(19) United States
(12) Patent Application Publication
(10) Pub. No.: US 2020/0109598 A1
(43) Pub. Date: Apr. 9, 2020

(54) WINDOW SILL PANS AND METHODS OF INSTALLATION OF SAME

(71) Applicant: GREEN SILL INC., Edmonton International Airport (CA)

(72) Inventor: Andrew ROUNG, Edmonton (CA)

(21) Appl. No.: 16/153,699

(22) Filed: Oct. 5, 2018

(51) Int. Cl. E06B 7/14

(52) U.S. Cl. CPC E06B 7/14

(57) ABSTRACT

A window sill pan for directing moisture toward an exterior side of a window frame may have a base member mounted along a window frame sill and sloped to drain liquid toward the exterior side of the window frame, corner members adjacent left and right ends, respectively, of the base member, with each corner member having a stud part, which extends up at least a lower part of a respective stud of the window frame, and a sill part mounted along the window frame sill toward the base member, and a membrane adhered to, and forming a water impermeable envelope that covers, external surfaces of the base member, the corner members, the window frame sill and the lower parts of the studs.

### BACKGROUND

Inclined strips are laid across a lower window frame member, and partially up inner surfaces of the opposing vertical frame members, of a window frame. A window is positioned in the frame and rests upon the strips, to permit moisture to drain to the exterior of the building.

### SUMMARY

A window sill pan for directing moisture toward an exterior side of a window frame is disclosed, the window sill pan comprising: a base member mounted along a window frame sill and sloped to drain liquid toward the exterior side of the window frame; corner members adjacent left and right ends, respectively, of the base member, with each corner member having a stud part, which extends up at least a lower part of a respective stud of the window frame, and a sill part mounted along the window frame sill toward the base member; and a membrane adhered to, and forming a water impermeable envelope that covers, external surfaces of the base member, the corner members, the window frame sill and the lower parts of the studs.

A method is also disclosed comprising: securing a base member and corner members along a window frame sill and lower inside corners, respectively, of a window frame, the base member being sloped to drain liquid toward an exterior side of the window frame; adhering a membrane to the base member, the corner members, and the window frame to form a water impermeable envelope that covers external surfaces of the base member, the corner members, lower parts of studs of the window frame, and the window frame sill; and securing a window within the window frame above the base members and corner members.

A kit for directing moisture toward an exterior side of a window frame is also disclosed, the kit comprising: a base member sloped to in use drain liquid toward the exterior side of the window frame; corner members, with each corner member having a stud-contacting part and a sill-contacting part; and a water impermeable membrane for extending from an interior side of the window frame to the exterior side, the water impermeable membrane structured to in use cover external surfaces of the base member, the corner members, a window frame sill of the window frame, and lower parts of studs of the window frame to form a water impermeable envelope.

A method is also disclosed comprising: securing a base member and corner members along a window frame sill and lower inside corners, respectively, of a window frame, with each corner member having a stud part, which extends up at least a lower part of a respective stud of the window frame, and a sill part mounted along the window frame sill toward the base member, in which the stud parts of the corner members have a longitudinal length sufficient to extend each stud part 6 inches or more up the respective stud, with the base member having a solid core, the corner members forming universal corner members that are identical to one another, the base member being sloped to drain liquid toward an exterior side of the window frame, the stud parts and sill parts of the corner members each being sloped to drain liquid toward the exterior side of the window frame, in which the base member and the corner members are secured via an adhesive, in which adhering the base member and the corner members along the window frame sill and lower inside corners comprises a) peeling off release liners that are layered on respective adhesive backings on the base member and the corner members, and b) positioning the base member and corner members such that the respective adhesive backings contact and adhere to the window frame sill and lower inside corners, respectively, of the window frame, the base member and corner members comprising polyvinylchloride (PVC); adhering a membrane to the base member, the corner members, and the window frame to form a water impermeable envelope that covers external surfaces of the base member, the corner members, lower parts of studs of the window frame, and the window frame sill, in which the membrane comprises a) a first elongate strip that wraps around the window frame sill from the exterior side to an interior side of the window frame, with the first elongate strip oriented to extend along its axis down the lower part of one of the respective studs, along the window frame sill and over the base member, and up the lower part of the other of the respective studs, and b) a second elongate strip that wraps around the window frame sill from the exterior side to the interior side, with the second elongate strip oriented to extend along its axis along respective interfaces defined between the window frame sill and each respective stud; securing a shim on a top exterior surface of the membrane over the window frame sill between the base member and the exterior side of the window frame, in which the shim has the same cross-sectional shape as the base member and is sloped to drain liquid toward the exterior side of the window frame; and securing a window within the window frame above the base members and corner members.

A window sill pan for directing moisture toward an exterior side of a window frame is also disclosed, the window sill pan comprising: a base member mounted along a window frame sill sloped to drain liquid toward the exterior side of the window frame; corner members adjacent left and right ends, respectively, of the base member, with each corner member having a stud part, which extends up at least a lower part of a respective stud of the window frame, and a sill part mounted along the window frame sill toward the base member; and a membrane adhered to, and forming a water impermeable envelope that covers, external surfaces of the base member, the corner members, the window frame sill and the lower parts of the studs; in which the base member has a solid core.

A window sill pan for directing moisture toward an exterior side of a window frame is also disclosed, the window sill pan comprising: a base member mounted along a window frame sill via an adhesive and sloped to drain liquid toward the exterior side of the window frame; corner members adjacent left and right ends, respectively, of the base member, with each corner member having a stud part, which extends up at least a lower part of a respective stud of the window frame, and a sill part mounted along the window frame sill toward the base member; and a membrane adhered to, and forming a water impermeable envelope that covers, external surfaces of the base member, the corner members, the window frame sill and the lower parts of the studs.

In various embodiments, there may be included any one or more of the following features: The base member is mounted along the window frame sill via an adhesive. The adhesive is provided as an adhesive backing on a base face of the base member. The stud parts and sill parts of the corner members are each sloped to drain liquid toward the exterior side of the window frame. The stud parts of the corner members have a longitudinal length sufficient to extend each stud part 6 inches or more up the respective stud. The window sill pan comprises a shim secured on the membrane over the window frame sill and between the base member and the exterior side of the window frame. The shim has the same cross-sectional shape as the base member and is sloped to drain liquid toward the exterior side of the window frame. The base member has a solid core. The corner members form universal corner members that are identical to one another. The base member and corner members comprise polyvinylchloride (PVC). The membrane comprises: a first elongate strip that wraps around the window frame sill from the exterior side to an interior side of the window frame, with the first elongate strip oriented to extend along its axis down the lower part of one of the respective studs, along the window frame sill and over the base member, and up the lower part of the other of the respective studs; and a second elongate strip that wraps around the window frame sill from the exterior side to the interior side, with the second elongate strip oriented to extend along its axis along respective interfaces defined between the window frame sill and each respective stud. The base member and the corner members are secured via an adhesive. Adhering the base member and the corner members along the window frame sill and lower inside corners comprises: peeling off release liners that are layered on respective adhesive backings on the base member and the corner members; and positioning the base member and corner members such that the respective adhesive backings contact and adhere to the window frame sill and lower inside corners, respectively, of the window frame. After adhering the membrane and before securing the window, securing a shim on a top exterior surface of the membrane between the base member and the exterior side of the window frame. The base member has a solid core. The kit comprises a written matter describing instructions for assembling the parts into a window sill pan on a window frame. The kit comprises release liners that are layered on respective adhesive backings on the base member and the corner members.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of a window sill pan mounted to a window frame.

FIG. 2 is a perspective view of the window sill pan of FIG. 1 with a membrane secured over the base and corner members of the pan, and secured over the window frame, with shims secured on the membrane.

FIG. 3 is an exploded side elevation view of a base member and membrane of the window sill pan of FIG. 1, with both the base member and membrane having respective adhesive backings and release liners.

FIG. 4 is an exploded view taken along the 4-4 section lines in FIG. 1 to illustrate adhesion of the base member of the window sill pan of FIG. 1 to the window frame.

FIG. 5 is a front elevation view of the window sill pan of FIG. 1 adhered to the window frame.

FIG. 6 is a top plan view of the window sill pan and the window frame of FIG. 1.

FIG. 7 is a section view taken along the 7-7 section lines of FIG. 2 illustrating a window supported on the base member, shim, and corner member of the window sill pan of FIG. 1, with the membrane not shown for illustrative purposes.

FIGS. 8A-8B are a series of perspective views illustrating embodiments of various shapes of membranes laid along the inside corners of the window frame and sill pan.

### DETAILED DESCRIPTION

Immaterial modifications may be made to the embodiments described here without departing from what is covered by the claims.

Moisture infiltration, for example caused by rain, melting snow or ice, or condensation of moisture vapor, can occur through the joints of a window or window frame. Such infiltration can also occur via through-wall passages and other openings in the building, behind deck ledger boards, within a corner of an exterior wall or wall-to-roof interface, or at other areas of a building structure. Moisture that infiltrates such areas may become trapped within the building structure and over time cause structural damage such as rotting of window sills, framing elements, ledgers, joists, adjacent wall or roof sheathing and studs, and exterior sidewall and trim building materials. In addition, trapped moisture may cause undesired growth of mold within the wall or adjacent structure, leading to structural damage and unsanitary interior conditions.

To minimize or prevent such damage, a sill pan flashing material may be installed to a window frame before the window is installed within the frame opening. The sill pan provides a water impermeable layer of material that prevents moisture, which may infiltrate the opening, from contacting wooden members of the window frame and other surfaces within the wall. The sill pan may also promote removal of moisture from the window sill area to an area on an exterior side of the building envelope. A sill pan may thus be used to prevent structural damage of the building structure about the window opening, drain moisture to an exterior side of the building, and lessen the likelihood of mold forming within the walls of the structure.

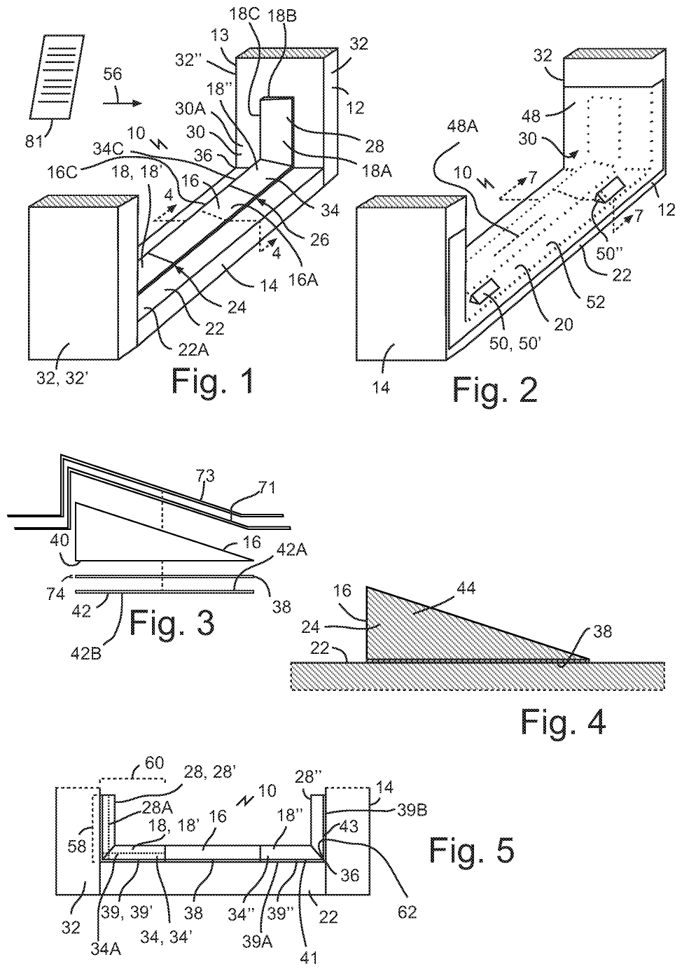

Referring to FIGS. 1 and 2, a window sill pan 10 is illustrated for directing moisture toward an exterior side 12 of a window frame 14. Pan 10 comprises a base member 16, left and right corner members 18, and a membrane 20 (FIG. 2). The base member 16 may be mounted along a window frame sill 22. The base member 16 may be sloped to drain liquid toward the exterior side 12 of the window frame 14. The corner members 18 may be positioned adjacent left and right ends 24 and 26, respectively, of the base member 16. Each corner member 18 may have a stud-contacting part 28, for example that extends up at least a lower part 30 of a respective stud 32 of the window frame 14, and a sill-contacting part 34, for example mounted along the window frame sill 22 toward the base member 16. Referring to FIGS. 1 and 2, the membrane 20 (shown in FIG. 2) may be adhered to, and form a water impermeable envelope that covers respective external surfaces 16A, 18A, 22A, and 30A (shown in FIG. 1) of the base member 16, the corner members 18, the window frame sill 22, and lower parts 30 of the studs 32. The base member 16 and the corner members 18 may be secured along the window frame sill 22 and lower inside corners 36, respectively, of the window frame 14. One or more of the base member 16 and the corner members 18 may made of a suitable material, such as a polymer for example polyvinyl chloride (PVC).

Referring to FIG. 5, one or more of the base member 16 and the corner members 18 may be mounted (for example secured) along the window frame sill 22 via an adhesive. Referring to FIGS. 3 and 5, the adhesive may be provided as an adhesive layer such as a backing 38 on a base face 40 (FIG. 3) of the base member 16. Referring to FIG. 5, an adhesive backing 39, such as backings 39A and 39B, may be provided on surfaces of the corner members 18, such as base and side surfaces 41 and 43, respectively.

Referring to FIGS. 3 and 5, one or more of the respective adhesive backings 38 and 39 may be provided as part of a peel and stick adhesion system. Each backing may have a uniform thickness 74 at all parts of the backing, with the thickness 74 defined as the dimension between the base member 16 or corner member 18 and the window frame 14 in use. A uniform thickness provides an automatic mechanism of levelling or aligning the member in the frame 14, as opposed to when glue or other adhesive is manually applied leading to inconsistent thicknesses of adhesive along the length of the members. Each backing may completely cover the surface of the base member 16 or corner member 18 upon which the backing is placed, for example the entirety of base face 40 of base member 16 may be covered by backing 38. Referring to FIG. 3, one or more of the base member 16 and the corner members 18 may be provided with a release liner 42, for example layered, prior to installation, on one or more of the respective adhesive backing, such as on backing 38 shown. A release liner may comprise a sheet, such as a paper or plastic-based film sheet (usually applied during the manufacturing process) used to prevent a sticky surface, such as the adhesive backings discussed above, from prematurely adhering to a surface. The release liner 42 may be coated on one or both faces 42A or 42B with a release agent, such as wax, which provides a release effect against any type of a sticky material such as an adhesive or a mastic. The release liner 42 may be peeled off prior to securing the base member 16 and the corner members 18 to the window frame 14, for example to permit securing the base member 16 and the corner members 18 in a peel and stick fashion. The base member 16 and the corner members 18 may be positioned such that the respective adhesive backings 38 and 39 contact the window frame sill 22 and lower inside corners 36, respectively, of the window frame 14. In some cases, one or both the base members 16 or corner members 18 are secured to the window frame 14 via other suitable means, such as by mechanical fasteners, for example nails or screws, or other suitable parts or methods.

Referring to FIGS. 4 and 6-7, one or more of the base member 16 and the corner members 18 may have a solid core 44. The solid core 44 may be evidence by a non-hollow, uniform cross-sectional composition and density, lacking in voids, from edge to edge and end to end and surface to surface. For example, the core 44 of base member 16 may form a filled wedge of uniform cross-section. A solid core may form or provide a more effective thermal break than a non-solid member with internal voids or air pockets or a wood part, for example to minimize or reduce thermal energy loss across the window frame 14 relative to a member with a non-solid core. PVC has a lower conductivity than wood, contributing to the improved thermal break character. The members 16 and 18 may be formed by suitable methods such as injection molding or extrusion. In some cases the base member 16 has a solid core but at least a portion of the corner members 18, such as the stud parts 28, is hollow, for example indented to form fins defining air gaps between adjacent fins.

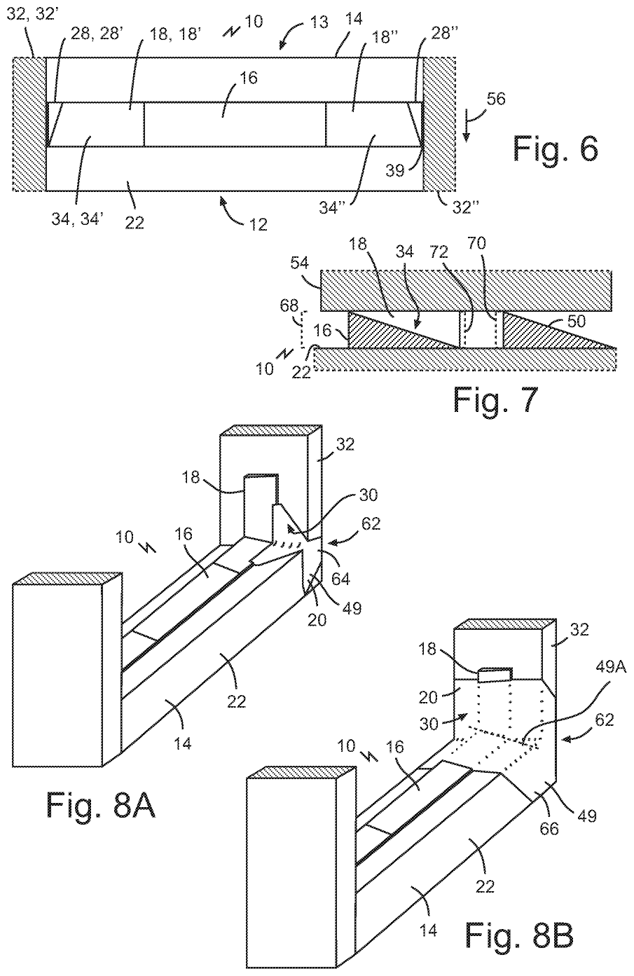

Referring to FIGS. 1 and 6, the corner members 18 may each have a structure suitable for directing moisture toward the exterior side 12 of the window frame 14. One or both the stud parts 28 and the sill parts 34 of the corner members 18 may each be sloped to drain liquid toward the exterior side 12 of the window frame 14. A right sill part 34″ of a right corner member 18″ and/or a left sill part 34′ of a left corner member 18′ may be tapered with decreasing distance from the window frame sill 22 in a direction 56 from an interior side 13 of the window frame 14 to the exterior side 12 of the window frame 14, for example as illustrated in FIG. 1. Referring to FIG. 6, a left stud part 28′ of the left corner member 18′ may be tapered with decreasing distance from a left stud 32′ in the direction 56. A right stud part 28″ of the right corner member 18″ may be tapered with decreasing distance from a right stud 32″ in the direction 56. The tapered surface may form a suitable angle with the window frame, such as between five and forty-five degrees, for example fifteen degrees. Each member (members 16 or 18) may have a suitable height 68, for example ¾ inch.

Referring to FIG. 5, the corner members 18 may have suitable dimensions. The stud parts 28 of the corner members 18 may have a longitudinal length 58 (for example defined along a central axis 28A) sufficient to extend each stud part 28 six inches or more up the respective stud 32. A six-inch height (length 58) may provide additional protection relative to a shorter stud part, by extending the stud part above a height that water penetrating sill 22 may otherwise migrate or wick upwards along studs 32, and by reducing ingress from driving rain. The sill parts 34 of the corner members 18 may have suitable dimensions, for example a longitudinal length 60 (for example defined along a central axis 34A) equal to six inches or more.

Referring to FIG. 5, each corner members 18 may be structured to permit interchangeable use as a left corner member 18′ or right corner member 18″. The corner members 18 may form universal corner members 18, for example that are identical to one another. The parts 28 and 34 may be oriented such that surfaces at right angles relative to one another, or other suitable angles. The longitudinal length of the left stud part 28′ may be equal to the longitudinal length of the right sill part 34″, and/or the longitudinal length of the right stud part 28″ may be equal to the longitudinal length of the left sill part 34′. Such dimensions may permit use of the left corner member 18′ as the right corner member 18″ when rotated 90 degrees and/or use of the right corner member 18″ as the left corner member 18′ when rotated 90 degrees.

Referring to FIGS. 2 and 8A-8B, the membrane 20 may have a structure suitable for forming a water impermeable envelope. Referring to FIGS. 1 and 2, the membrane 20 may be formed of an elongate strip or elongate strips 48 of membrane 20 that extend axially along the base member 16 (FIG. 1), the window frame sill 22, and the lower parts 30 of the studs 32. Elongate strip 48 may wrap around the window frame sill 22 from the exterior side 12 to an interior side 11 of the window frame 14. The elongate strip 48 (first elongate strip) may be oriented to extend along its axis 48A (FIG. 2) down the lower part 30 of one of the respective studs 32, along the window frame sill 22 and over the base member 16, and up the lower part 30 of the other of the respective studs 32. The strip 48 may be made up of a single strip, or plural strips arranged in one or more of series or parallel or other configurations, with overlapping edges.

Referring to FIGS. 8A-8B, the membrane 20 may be formed of an elongate strip or elongate strips 49 (second elongate strip) of membrane 20 that extends axially along respective interfaces 62 defined between each stud 32 and the window frame sill 22. Elongate strip 49 may wrap around the window frame sill 22 from the exterior side 12 to the interior side 13. Elongate strip 49 may be oriented to extend along its axis 49A along respective interfaces 62 defined between the window frame sill 22 and each respective stud 32. The elongate strip or elongate strips 49 of membrane 20 that extend axially along the interfaces 62 may have a butterfly (also known as an hourglass) shaped strip 64 as illustrated in FIG. 8A, a rectangular strip 66 as illustrated in FIG. 8B, or another suitable shape. The elongate strip 49 may be secured to the window sill pan 10 and the window frame 14 prior to securing the elongate strip 48 to the window sill pan 10 and the window frame 14.

Referring to FIGS. 2 and 8A-8B, the elongate strips 48 (FIGS. 2) and 49 may be made of polypropylene, rubberized asphalt, or other suitable materials. The elongate strips 48 and 49 may be pliable, for example to permit the elongate strips 48 and 49 to conform to the shape of the window sill pan 10 and the window frame 14 when secured to the window sill pan 10 and the window frame 14.

Referring to FIGS. 1-2 and 8A-8B, the membrane 20 may have a structure suitable for adhering the membrane 20 to the base member 16, the corner members 18, and the window frame 14, for example to form a water impermeable envelope about the lower region of the window frame 14. Membrane 20 may cover respective external surfaces, such as surfaces 16A, 18A, 30A, and 22A (FIG. 1) of the base member 16, the corner members 18, the lower parts 30 of studs 32 of the window frame 14, and the window frame sill 22. The membrane 20 may conform to the external shape of the parts, such as if the membrane 20 also covers external surfaces 18B and 18C of stud contacting part 28, 34C of sill part 34, and 16C of base member 16. Referring to FIG. 3, one or more of the elongate strips 48 and 49 may be provided with an adhesive backing 71 and, at least initially (before installation on a window frame 14), with a release liner 73, for example that permits the elongate strips 48 and 49 to be adhered to the window sill pan 10 and the window frame 14 in a peel and stick fashion.

Referring to FIG. 7, the window sill pan 10 may have a structure suitable for snugly supporting and aligning a window 54 within frame 14. Referring to FIG. 2, the window sill pan 10 may comprise one or more shims 50, for example shims 50′ and 50″, secured on the membrane 20 between the base member 16 (FIG. 1) and the exterior side 12 of the window frame 14, for example on a top exterior surface 52 of the membrane 20. In some cases, the shim 50 is secured to the window frame sill 22 under the membrane 20 as shown. The shim 50 may be secured in a peel and stick fashion, for example using an adhesive backing and release liner (not shown), or by another suitable method. The shim 50 may have the same cross-sectional shape as the base member 16, for example if the shim 50 is provided by using part of base member 16 (for example a piece cut off of member 16) or by using a second base member 16. The shim 50 may be formed or cut from one or more of the left and right ends 24 and 26 (FIG. 1) of the base member 16. The shim 50 may be sloped to drain liquid toward the exterior side 12 of the window frame 14. Referring to FIG. 7, the respective maximum heights 68, 70, and 72 of the base member 16, the shim 50, and the sill parts 34 may be equal to one another, for example to align and in some cases level the window 54 relative to the window frame sill 22 when the window 54 is secured within the window frame 14. The window 54 may be a vinyl window, punched aluminum window, or another suitable window.

Referring to FIGS. 1-7 and 8A-8B, the window sill pan 10 and the window 54 may be secured within the window frame 14 via a suitable method. The release liners 42, for example layered on respective adhesive backings 38 and 39 on the base member 16 and the corner members 18 may be peeled off to expose the backings. The base member 16 and corner members 18 may be positioned such that the respective adhesive backings 38 and 39 contact and adhere to the window frame sill 22 and lower inside corners 36, respectively, of the window frame 14. Elongate strips 49, for example butterfly seal part 64 (FIG. 8A), the rectangular strips 66 (FIG. 8B), or other suitable elongate strips 49 may be adhered to one or more of the corner members 18, the window frame sill 22, and the studs 32, for example in a peel and stick fashion, for example to wrap around from side 12 to side 13 of frame 14. The elongate strip or strips 48 may be adhered to one or more of the base member 16, the corner members 18, the window frame 14, and elongate strips 49, for example in a peel and stick fashion, for example to wrap around from side 12 to side 13 of frame 14, forming a water impermeable envelope. In some cases, the elongate strip or strips 48 are adhered directly to corner members 18. A shim or shims 50 may be secured or adhered on the top exterior surface 52 of the membrane 20 between the base member 16 and the exterior side 12 of the window frame 14 (FIG. 1). In some cases, the shim 50 is secured directly to the window frame sill 22 beneath the elongate strip or strips 48. Referring to FIG. 7, a window 54 may be secured within the window frame 14 above one or more of the base member 16, the sill parts 34, and the shim 50 .

Referring to FIGS. 1-7 and 8A-8B, the window sill pan 10 may be provided in the form of a kit. The kit may comprise the base member 16 and the corner members 18, with each corner member 18 having the stud-contacting part or the stud part 28 and the sill-contacting part or the sill part 34. The kit may also comprise the membrane 20. The kit may comprise a written matter 81 (FIG. 1), for example a paper document or electronic document saved on a computer readable medium, describing instructions for assembling the parts into the window sill pan 10 on the window frame 14. The kit may comprise release liners 42 (FIG. 3), for example that are layered on respective adhesive backings 38 and 39 on the base member 16 and the corner members 18. The kit may comprise release liners 73 (FIG. 3), for example that are layered on respective adhesive backings 71 on the membrane 20.

The window sill pan 10 may be mounted to a door frame, for example to direct moisture toward an exterior side of the door frame. A door, for example an exterior door or sliding patio door, may be secured within the door frame and positioned on one or more of the base member 16, the corner members 18, and the shims 50. The corner members 18 may comprise fins (not shown). A suitable adhesive may comprise double-sided tape. A finned back member may be adhered by filling the gaps between fins with adhesive, such as silicon glue. Suitable materials may be fire retardant, for example window grade PVC. Suitable materials include materials that are flexible at relative cold ambient temperatures, such as temperatures below zero degrees Celsius and above minus thirty Celsius in some cases. In some cases the members 16 and 18 form a cap over surface 22A of sill 22, completely covering surface 22A. The base surfaces of members 16 and 18, and in some cases the side surfaces of members 18, may be ridged, for example similar to shark skin, for example to improve gripping against frame 14 and in some cases to increase surface area with which to bond with adhesive. The base surfaces of members 16 and 18, and in some cases the side surfaces of members 18, may have prong that depend below to pin the members to the wood frame 14. The members 16 and 18 may have pre-drilled holes through which fasteners may be inserted to secure same to frame 14. Butterfly or other corner membrane parts 64 may be pre-attached to corner members 18. In some cases members 16 and/or 18 may not be adhered or secured by fasteners to frame 14 other than being held down in place by membrane 20. Membrane 20 may overlap exterior sheathing or water impermeable building envelope membrane.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A window sill pan for directing moisture toward an exterior side of a window frame, the window sill pan comprising:
a base member mounted along a window frame sill and sloped to drain liquid toward the exterior side of the window frame;
corner members adjacent left and right ends, respectively, of the base member, with each corner member having a stud part, which extends up at least a lower part of a respective stud of the window frame, and a sill part mounted along the window frame sill toward the base member; and
a membrane adhered to, and forming a water impermeable envelope that covers, external surfaces of the base member, the corner members, the window frame sill and the lower parts of the studs.

2. The window sill pan of claim 1 in which the base member is mounted along the window frame sill via an adhesive.

3. The window sill pan of claim 2 in which the adhesive is provided as an adhesive backing on a base face of the base member.

4. The window sill pan of claim 1 in which the stud parts and sill parts of the corner members are each sloped to drain liquid toward the exterior side of the window frame.

5. The window sill pan of claim 1 in which the stud parts of the corner members have a longitudinal length sufficient to extend each stud part 6 inches or more up the respective stud.

6. The window sill pan of claim 1 further comprising a shim secured on the membrane over the window frame sill and between the base member and the exterior side of the window frame.

7. The window sill pan of claim 6 in which the shim has the same cross-sectional shape as the base member and is sloped to drain liquid toward the exterior side of the window frame.

8. The window sill pan of claim 1 in which the base member has a solid core.

9. The window sill pan of claim 1 in which the corner members form universal corner members that are identical to one another.

10. The window sill pan of claim 1 in which the base member and corner members comprise polyvinylchloride (PVC).

11. The window sill pan of claim 1 in which the membrane comprises:
a first elongate strip that wraps around the window frame sill from the exterior side to an interior side of the window frame, with the first elongate strip oriented to extend along its axis down the lower part of one of the respective studs, along the window frame sill and over the base member, and up the lower part of the other of the respective studs; and
a second elongate strip that wraps around the window frame sill from the exterior side to the interior side, with the second elongate strip oriented to extend along its axis along respective interfaces defined between the window frame sill and each respective stud.

12. A method comprising:
securing a base member and corner members along a window frame sill and lower inside corners, respectively, of a window frame, the base member being sloped to drain liquid toward an exterior side of the window frame;
adhering a membrane to the base member, the corner members, and the window frame to form a water impermeable envelope that covers external surfaces of the base member, the corner members, lower parts of studs of the window frame, and the window frame sill; and
securing a window within the window frame above the base members and corner members.

13. The method of claim 12 in which the base member and the corner members are secured via an adhesive.

14. The method of claim 13 in which adhering the base member and the corner members along the window frame sill and lower inside corners comprises:
peeling off release liners that are layered on respective adhesive backings on the base member and the corner members; and
positioning the base member and corner members such that the respective adhesive backings contact and adhere to the window frame sill and lower inside corners, respectively, of the window frame.

15. The method of claim 12 further comprising, after adhering the membrane and before securing the window, securing a shim on a top exterior surface of the membrane between the base member and the exterior side of the window frame.

16. The method of claim 12 in which the base member has a solid core.

17. A kit for directing moisture toward an exterior side of a window frame, the kit comprising:
a base member sloped to in use drain liquid toward the exterior side of the window frame;
corner members, with each corner member having a stud-contacting part and a sill-contacting part; and
a water impermeable membrane for extending from an interior side of the window frame to the exterior side, the water impermeable membrane structured to in use cover external surfaces of the base member, the corner members, a window frame sill of the window frame, and lower parts of studs of the window frame to form a water impermeable envelope.

18. The kit of claim 17 further comprising a written matter describing instructions for assembling the parts into a window sill pan on a window frame.

19. The kit of claim 17 further comprising release liners that are layered on respective adhesive backings on the base member and the corner members.

20. (canceled)
